(19) United States
(12) Patent Application Publication
(10) Pub. No.: US 2020/0034681 A1
(43) Pub. Date: Jan. 30, 2020

(54) Method and apparatus for automatically converting spreadsheets into conversational robots (or bots) with little or no human programming required simply by identifying, linking to or speaking the spreadsheet file name or digital location

(71) Applicant: Lorenzo Carver, San Francisco, CA (US)

(72) Inventor: Lorenzo Carver, San Francisco, CA (US)

(21) Appl. No.: 16/043,163

(22) Filed: Jul. 24, 2018

(51) Int. Cl. G06N 3/00; G06F 9/54; G06F 17/24

(52) U.S. Cl. CPC G06N 3/006; G06F 17/246; G06F 9/54

(57) ABSTRACT

An interactive conversation is generated automatically, including logic, sentences, images, help, calculations, deployment, testing and debugging, from an ordinary spreadsheets file into conversational robots (or “bots”) with little or no human programming required by spreadsheet uploader.

### FIELD OF THE INVENTION

The present invention involves an automated logic, conversation, calculation, deployment, testing and debugging system that converts spreadsheets into conversational robots (or “bots”) with little or no human programming required by the human uploading the spreadsheet. The present invention is configured to allow the technology to be applied to other document types such as word processor files, text files, portable document format files and other shareable content better suited for desktop than mobile, that can be converted into bots simply by clicking on, referencing or uploading the file to the system.

### BACKGROUND OF THE INVENTION

Bot, conversational robot and chatbot are all terms that describe software that enables machines to have textual or audio conversations in a manner that seems similar to a human dialogue. With the rise of mobile messaging worldwide, hundreds of millions of people are more capable of having a conversion via text than voice, often due to convenience and privacy, and as a result, texting is the most widely used application for mobile phones and other mobile internet devices.

Software that takes advantage of the familiar messaging interface, typically callout bubbles with text from one party to another, or from one party to a group, can eliminate one of the biggest barriers to user satisfaction, since little if any user interface education is needed to help the user achieve their goal, assuming that the software has the ability to properly interpret users desired input from the words and phrases they type of say. The layer that translates a user's phrases into intents is often described as artificial intelligence or AI, and relies on what is frequently referred to as Natural Language Processing (NLP).

In the same way that emoticons, photos and videos can increase rapport in a human to human text conversation, images can bring the user closer in a chatbot conversation. Similarly, an image can help users quickly get an idea of what the text is trying to describe.

As easy as a well-developed chatbot is for the end user to derive a benefit from, it still requires a substantial investment of time by a programmer, an artist, someone with domain expertise, a network admin, a content developer or script writer and so forth. While someone with programming expertise could (and often does) perform each of these roles for simple chatbots in a day, significant time is required to gather domain information from subject matter experts if the goal of the bot is to help a user with a financial, legal, accounting or marketing need, for instance.

Similarly, the state for the art today is such that it is virtually impossible for someone that does have the domain expertise in finance, accounting, law or marketing (but not expertise in programming) to convert their knowledge into a well-developed chatbot that can help others, thereby attracting followers, collaborators, peers and ideally customers. Although platforms exist that attempt to make it easier for those with programming expertise to develop and deploy a chatbot, none of these current offerings are as intuitive and easy to use as a spreadsheet. For many of these professionals, their expertise is distilled, quantitatively, in spreadsheets. Some of these spreadsheets are used only by the spreadsheet creator or other members of the spreadsheet creator's team, where the spreadsheet owner is an business entity such as a corporation. In other cases, these spreadsheets are shared with peers outside of the business entity, peers of the spreadsheet creator with their permission, shared with other individuals outside of the organization or individual without the spreadsheet creator's permission. can With hundreds of millions of professionals using spreadsheets each day, and billions texting on mobile devices, what is needed in the art is a novel system, method and apparatus that can automatically convert the flexibility and programmability of a spreadsheet into the ease of use and accessibility of chatbot without knowledge of software programming on the part of the bot creator.

### SUMMARY OF THE INVENTION

The present invention is system and method that empowers creators, owners and users of spreadsheets to turn those spreadsheets into conversational robots simply by identifying the spreadsheet file's location or otherwise uploading it to the mobile application, website or other resource running the system. Upon uploading the document, the system parses language and logic giving the uploaded document a complexity rating after inputs, outputs, labels, headers, tab names and other attributes are converted into a conversational script. Within minutes or seconds of uploading the file, depending on the complexity, the bot creator is taken to a live running example of their newly created messenger bot and given the opportunity, within that bot, to rate it. If the bot creator gives it a rating of four stars or higher (or some other metric of quality), they are given the opportunity to share the bot with others that will be privately invited, via, text, social media messaging, voice, email or other channels, to test the bot. If private testers of the bot rate it at four stars or higher (or some other metric of quality), the bot creator is given the option to publish the bot to the general public for further testing, free use, paid use, centralized or decentralized auditing and optimization, or free use with in bot purchasing options, such as downloading output from the bot, accessing the original spreadsheets or portions thereof, a pdf, word file or other medium.

If the bot creator gives the alpha bot generated from their spreadsheet a rating of less than four stars for instance (or some other metric of quality), the bot creator is instructed to note textual comments (via typing or voice) concerning what's wrong with their bot. The system correlates these comments with the automated logic extraction and optimization applied to their spreadsheet and begins logging manual edits to the bot logic sequence and the proportion of inputs displayed as questions. This data is used to train the automatic logic extraction system for future bots with similar domain characteristics, as derived from formulas, texts, phrases and pairs of the same, analyzed during the automated transformation of other spreadsheets into conversational robots.

Throughout the life cycle of spreadsheets converted into bots, “spreadbots” if you will, feedback is used to generate improvements in speed, accuracy, usability and end user outcomes. In most cases, this feedback and collaboration benefits not just a single bot, as would be the case with a centralized only spreadsheet, but potentially a worldwide, decentralized network of millions or trillions of spreadbots coming together to form a shared, decentralized, global spreadbot, or a “terasheet.” Under one embodiment, compensation to certain bot creators, bot testers, bot commenters and developers that optimize training the system, can be allocated based on outcomes, spreadbot useful life, user expected retention rates and similar lifetime value metrics.

### BRIEF DESCRIPTION OF THE DRAWINGS

FIG. 1 Is an illustration of a desktop computer

FIG. 2 diagram illustrates a computer, which could be a handheld smart phone, wearable device, implanted device, laptop, desktop or similar device that can be used to run the system

FIG. 3 shows a flowchart of the spreadsheet logic, extraction, transformation and loading into spreadbot logic that simultaneously becomes a live alpha conversational bot for the bot creator's review in accordance with the present invention

FIG. 4 shows a flowchart of the spreadbot testers being invited to test the bot from the last block of FIG. 3 flowchart, rating the bot, their rating updating a smart contract linked to the bot expected remaining life, and the opportunity to extend bot life by getting help from a community of experts and AI bots attached to the smart contract in accordance with the present invention

FIG. 5 shows a mobile upload file for conversation dialogue that initiates the spreadsheet logic, extraction, transformation and loading into a spreadbot or conversational robot as shown in FIG. 2

FIG. 6 shows a mobile upload file for conversation dialogue that gives feedback as to the progression of the transformation progress of a spreadsheet into a conversational robot (spreadbot) as shown in FIG. 2

FIG. 7 shows a flowchart of the testers being invited to test the bot from the last block of FIG. 3 flowchart, rating the bot, their rating updating a smart contract linked to the bot expected remaining life, and the opportunity to extend bot life by getting help from a community of experts and AI bots attached to the smart contract in accordance with the present invention

FIG. 8 shows a sample spreadsheet illustrating how components that were never intended to be transformed into a conversational robot can automatically be so transformed in accordance with the present invention, as outlined in FIG. 3

FIG. 9 shows a the same spreadsheet in FIG. 8 but with the formulas displayed, as opposed to the outputs, to illustrate how the system identifies inputs and outputs to quickly generate a conversation that can produce request the required inputs from a user, via text or voice, to generate the outputs most relevant to a user, again via text and or voice, and thereby quickly generate ideas or produce outcomes for the user with the present invention, as outlined in FIG. 3

FIG. 10 shows an actual conversation, in this instance a text based conversation, generated within seconds of a user uploading a spreadsheet from a mobile device

FIG. 11 shows a continuation of the conversation shown in FIG. 11, generated by the created within seconds mobile upload file for conversation dialogue that initiates the spreadsheet logic, extraction, transformation and loading into a spreadbot (or spreadsheet converted conversational robot) as shown in FIG. 2

FIG. 12 illustrates a spreadbot summary generated in accordance with the invention, which includes the automatically generated bot description, category, tile, life, complexity and other elements in accordance with the present invention.

FIG. 13 illustrates a spreadbot logic and question editor interface generated in accordance with the invention, which includes the automatically ranked conversation question order and manifest.

FIG. 14 shows a continuation and conclusion of the conversation shown in FIG. 11, along with a request for rating by the bot author and/or bot tester generated by the created within seconds mobile upload file for conversation dialogue that initiates the spreadsheet logic, extraction, transformation and loading into a spreadbot (or spreadsheet converted conversational robot) as shown in FIG. 2

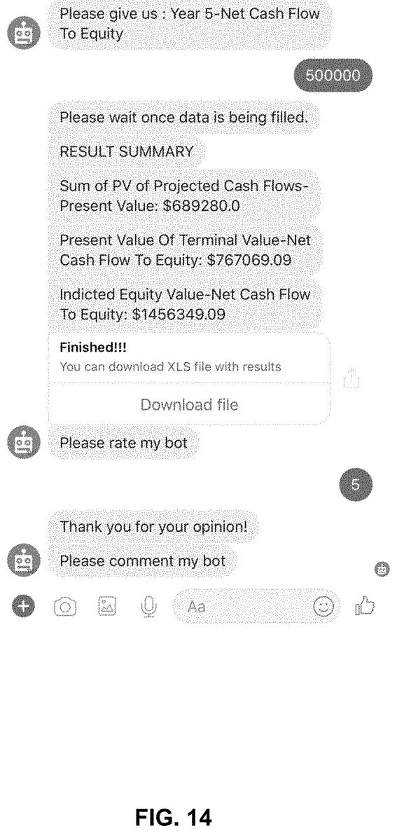

FIG. 15 illustrates an invitation to test a spreadbot in accordance with the invention.

### DETAILED DESCRIPTION OF THE PREFERRED EMBODIMENT

The present invention is described herein using terms that speak to a specific embodiment. However, for those skilled in the art substitutions, modifications, changes in sequence and other rearrangements can be applied without deserting the spirit of the invention.

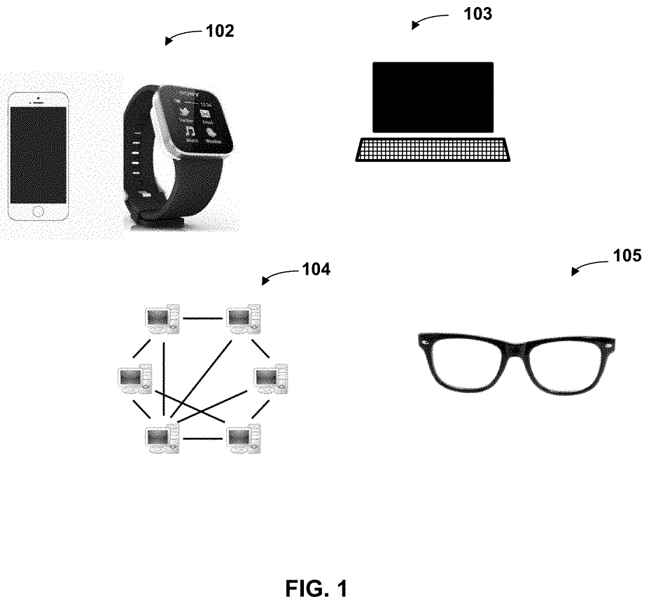

In FIG. 1 Is a block diagram of a generic computing device, any variation which can run the present invention, either in a browser or as a native application. FIG. 1 diagram illustrates a handheld smart phone computing device 101, a smart watch computing device 102, a desktop computer 103, a decentralized computer 104 and a wearable computer 105, in the form of a set of smart glasses. Any of the computing devices illustrates any others in the current art, and future art, that at can connect to the public, private or decentralized internet.

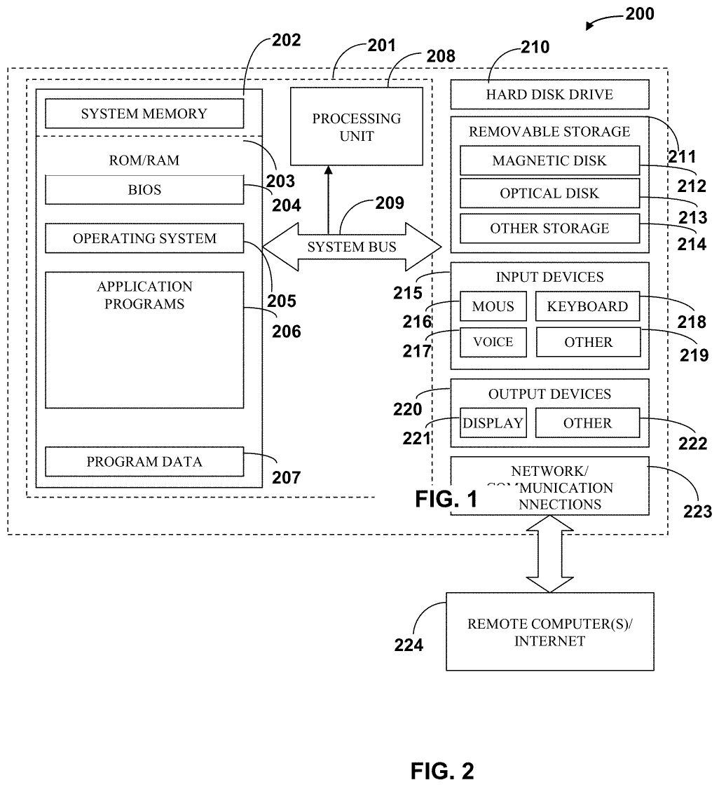

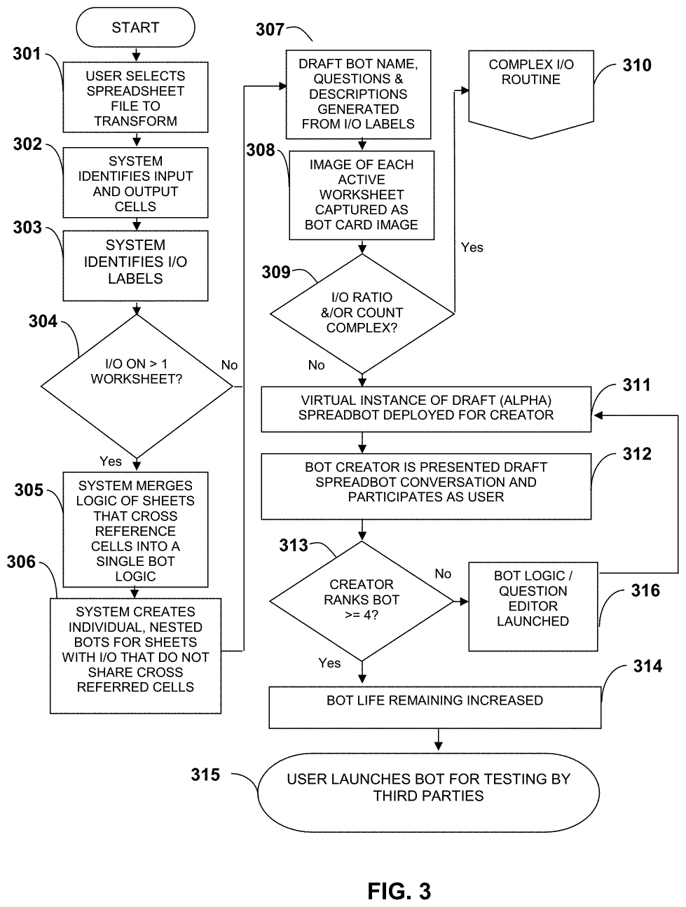

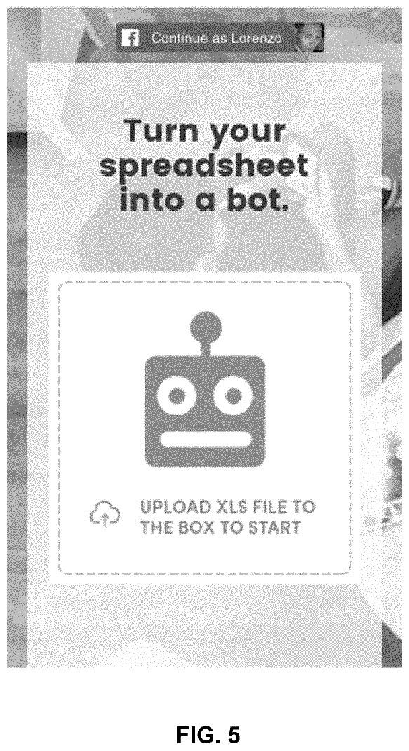

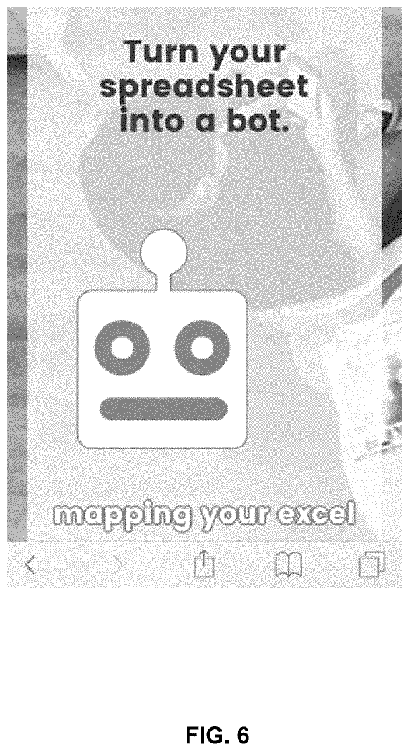

The flowchart in FIG. 3 diagrams the steps taken by the invention to automatically convert the user's uploaded spreadsheet 301, into logic, conversation, calculations, deployment, testing and debugging without any programming knowledge on the art of the user in 301. Once the use has identified, by typing, speaking, gesturing, linking or otherwise identifying the spreadsheet file, or dragging the file to a drop zone; extraction, transformation and loading into a spreadbot or conversational robot as shown in FIG. 2. FIG. 5 shows a sample user interface with drop zone for a file be selected from or dropped into. FIG. 6 shows the same interface screen, but with a textual update at the bottom whereby some of the processes in FIG. 3. are summarized in language any layperson can comprehend, such “mapping spreadsheet file”, “generating bot questions” and “deploying alpha of your bot.”

As soon as the spreadsheet file is identified or uploaded by the user in 301 of FIG. 3, the invention identifies the input and output cells, 302, and input and output, or “I/O” labels in 303 of the same figure. One of many ways the invention is able to almost instantly identify likely input and output sells is simply by looking for formulas, which are often dependent on independent numbers or variables that, in many cases represent cells intended be edited.

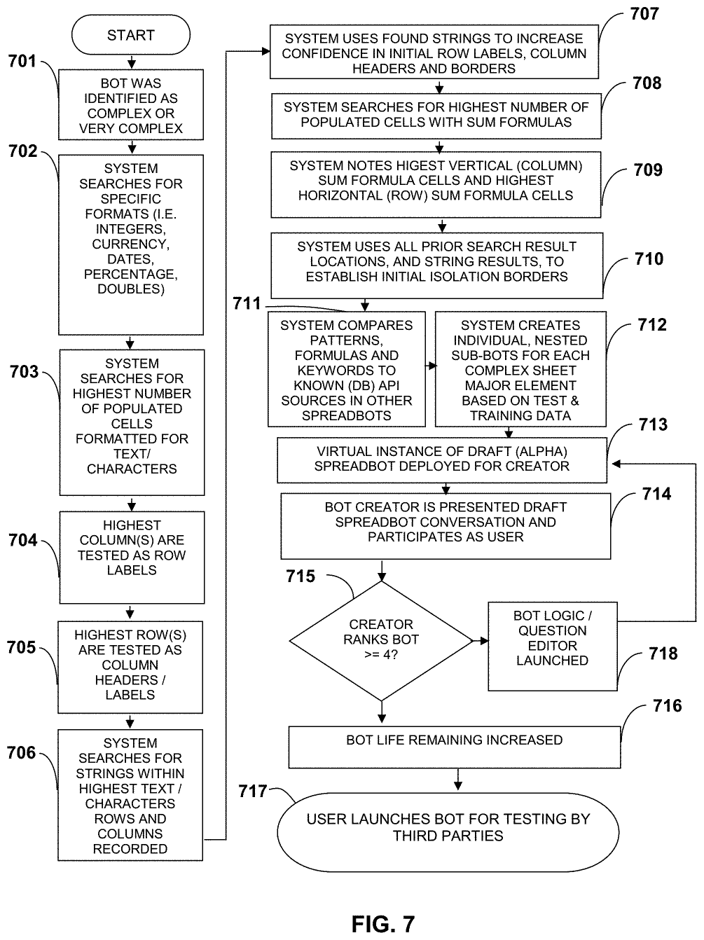

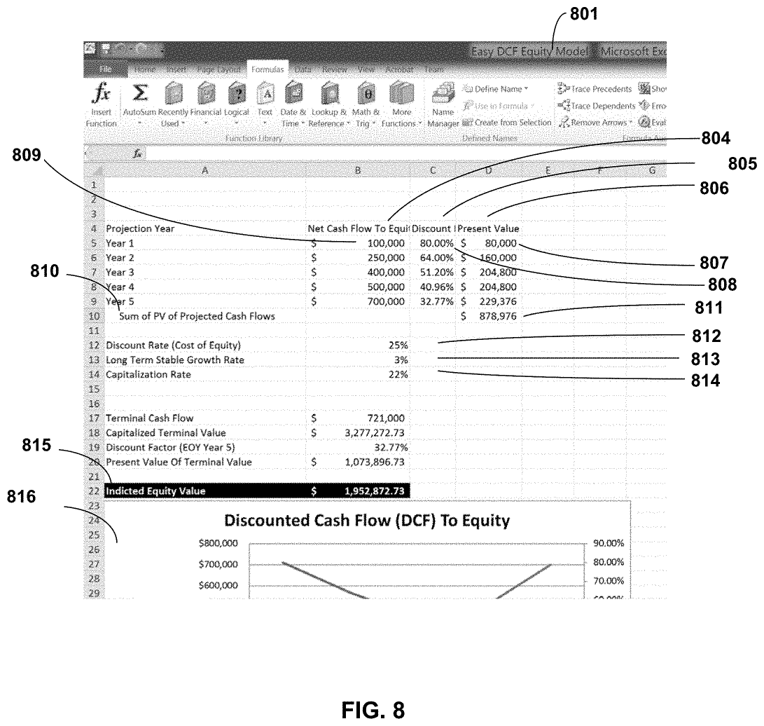

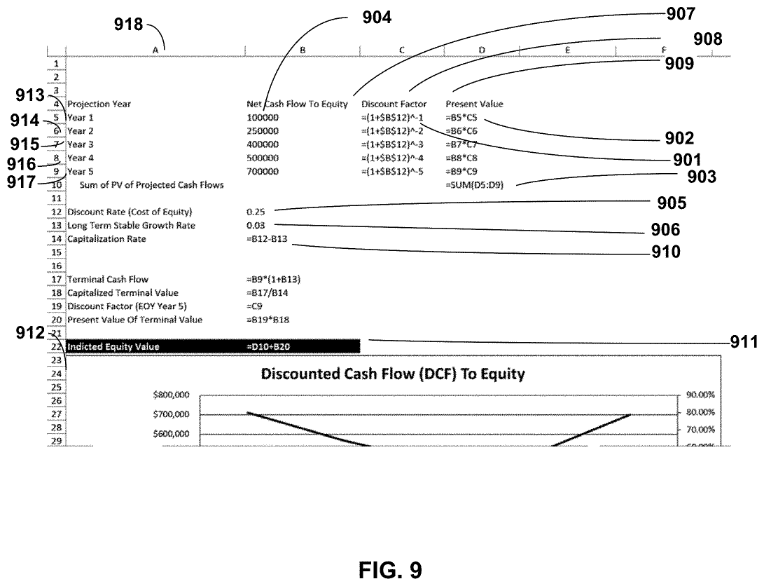

In FIG. 8 is a sample spreadsheet illustrating how components that were never intended to be transformed into a conversational robot can automatically be so transformed in accordance with the present invention, as outlined in FIG. 3. The sample spreadsheet in FIG. 8 is presented without formulas exposed as cell contents, which is the typical state of most spreadsheets when users open a workbook or worksheet. In 807, 808, 809, 811, 812, 813 and 814 of FIG. 8 are some of the cells in the sample workbooks that a typical spreadsheet user would recognize as containing values. More information about the types of values is communicated to the typical user first by the format in those same cells, such as currency (“$” dollar sign symbol) in 809 and percentage (“%” symbol) in the same FIG. 8, and of course by the adjacent or nearby row and/or column labels, such as 804, 805, 806 and 810 in FIG. 8. The present invention also relies on cells formats for information, particularly in the case of a complex spreadsheet, as shown in 309 and 310 of FIG. 3 as further referenced specifically in the Flowchart of FIG. 7, which is described in more detail later in this specification. However, without regard to labels or formats, simply identifying formulas and cells referenced by formulas within a spreadsheet is a highly reliable way to get an initial indication of potential inputs and outputs in accordance with 302 of FIG. 3. FIG. 9 helps illustrate this step further.

FIG. 9 shows the same spreadsheet is in FIG. 8, but with the formulas displayed, as opposed to the outputs, to illustrate how the system identifies inputs and outputs to quickly generate a conversation that can automatically request information for inputs from a user, via text or voice, to generate the outputs most relevant to a user, again via text and or voice, and thereby quickly generate ideas or produce outcomes for the user with the present invention, as outlined in FIG. 3.

For example, 904 of FIG. 9 shows a cell that doesn't contain a formula, but instead contains an integer. The integer in 904 is referenced directly by formulas in the cells indicated as 901 and 902, and indirectly by the cells indicated as 903 and 911. As such, the system can use this small amount of information to identify the four integers in the cells below 904, as well as 904, as input cells. Similarly, since the formulas, in 901, 902, 903 and 911 reference the input cells noted previously, all that's need to turn those observations into a conversation, in accordance with the present invention, are some words that describe the role these inputs and outputs play in solving a problem. Unlike the prior art, where questions and answers for conversational bots are generated by NLP or by script writers, which require a great deal of time prior to generating even a first prototypical chatbots, the present invention uses some of the cells identified as inputs to generate a fully formed text question and also to set the parameters for acceptable type of answers from a conversational bot users. This substantially decreases the time of developing a bot from hours to seconds, which of course decreases the cost and thereby increases the worldwide capacity to create useful conversation bots.

To illustrate how the example file shown in FIG. 8 and FIG. 9 can automatically be converted by the invention into logic, conversation and calculations, with one step by the bot creator and just six steps by the system, refer again to FIG. 3.

All the bot creator had to do was identify, by clicking on, dragging, saying, or otherwise indicating, the spreadsheet file they wanted to turn into a conversational robot, in 301 of FIG. 3. In 302 of the same figure, the system identified input and output cells from the spreadsheet file. With a list of inputs and outputs, the mathematical logic behind the spreadsheet is codified into bot logic that can be used to organize a conversation any user can participate in, once labels are associated with the inputs and outputs in accordance with the present invention as illustrated in 303 of FIG. 3.

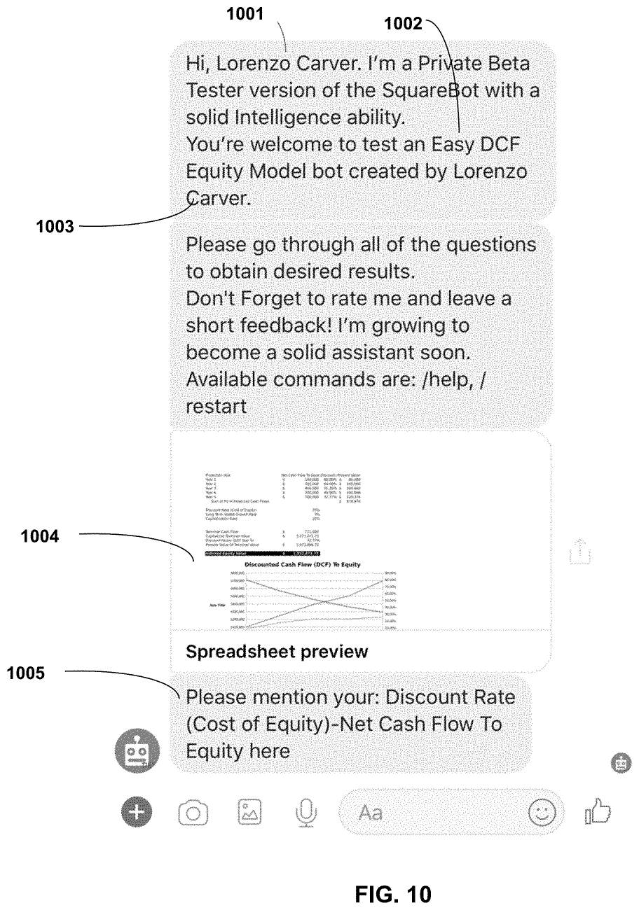

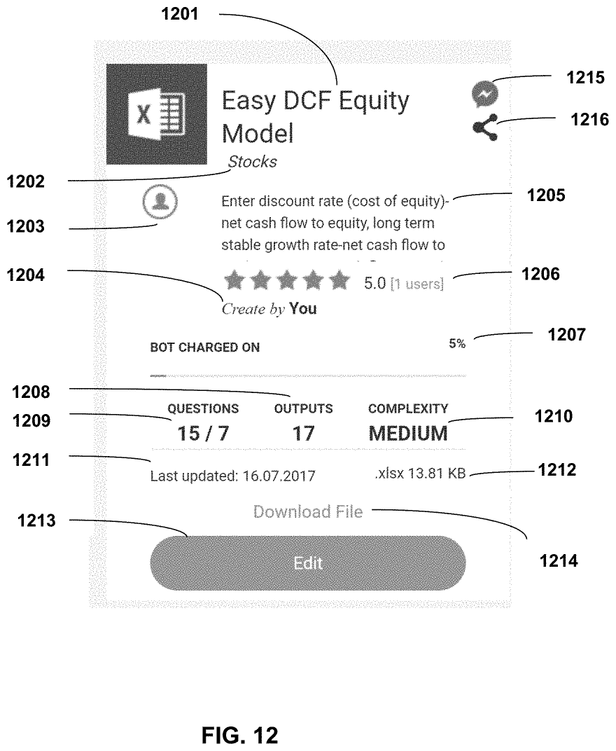

Since inputs and outputs were only identified on one worksheet, sample spreadsheet FIG. 8, there's no need to consider how to treat workbooks with more than one sheet of inputs and outputs, which are the conditional path steps in 305 and 306 of FIG. 3. This means the next step in the system is to draft a bot name (1002 of FIG. 10, narrow down the questions (if appropriate, FIG. 12). Each of these items happens simultaneously in 307, after which an thumbnail image of the active worksheet is captured to become a bot card image, FIG. 10, 1004.

Referring again to FIG. 10, it's clear how the combination of text, images, formulas and numeric values that would have been very difficult to read on a mobile device and impossible to convert into a set of useful audio instructions without coding, has been converted into a natural conversation that satisfies an important problem for the user. Unlike the prior art, there's no need for the bot creator to setup a Facebook or social media page, create a web hook, subscribe to web services needed to interface with messenger platforms, create databases, database index keys or even write a single sentence describing the bot, much less a single line of code. Just uploading the spreadsheet file generates a bot that uses the username on a messenger platform to address the user by name, as shown in 1001 of FIG. 10. This same conversational robot has a name automatically generated for it, using the file name for the spreadsheet as the bot name, as shown in 1002 and this same chatbot gives attribution to the bot creator, 1003. Naturally, this same conversational bot automatically begins asking the most important questions of the user in order to get them the most important answers the original spreadsheet was designed to solve for, 1005 of FIG. 10, along with subsequent questions.

Referring to the first question the bot asks the user, 1005 in FIG. 10, you'll note that this question uses the label from 905 of FIG. 9 as the basis for the question, even though there were a number of other inputs identified in the sample spreadsheet in FIG. 9. The cell horizontally adjacent in 905 of FIG. 9, B12 in the sample spreadsheet, contains an independent variable that's directly referenced six (6) times by formulas that depend on its value. No other input is referred to more frequently in the sample spreadsheet FIG. 9, so the system initially assumes this is the most important input needed from a user and places this question first automatically, even though many other inputs precede the order of B12 on the sample spreadsheet in FIG. 9. This process happens as part of the input and output (I/O) ratio analysis shown in 309 of FIG. 3. In the prior art, a spreadsheet user, that didn't create the spreadsheet, may have to read a long list of instructions and wade through row after row of inputs and outputs to determine what information they need to gather in order to get a result. For even a simple spreadsheet, this time represents a real financial cost and a strain on the productive capacity of the spreadsheet user. Simply transforming a spreadsheet into a text or voice conversation overcomes most of this time and cost burden. However, by optimizing the number of questions (inputs posed to the user as questions in the conversation), and even the number of answers (outputs presented to the user as or after they've answers questions, adds even greater efficiency.

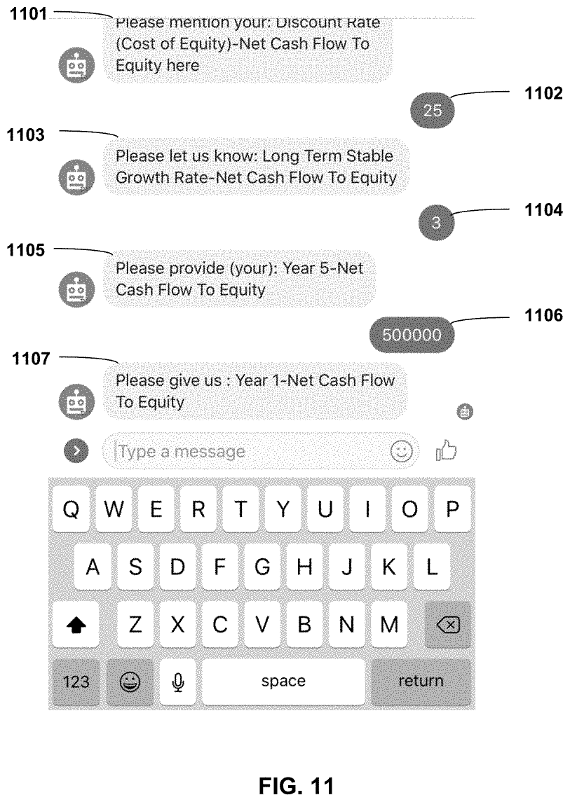

Closed form formulas and algorithms can work for optimizing the number, order and use of the most important questions and results in a conversation in many simple and medium complexity spreadsheets, as demonstrated by the present invention in the questions displayed in FIG. 10 and FIG. 11. However, spreadsheets are idiosyncratic and industries are unique with respect to key terminology and its related hierarchical logic. In order to continuously improve more effective automated assumptions for the ideal order, inclusion and rank, the present invention depends on training data feed into statistical learning methods known within the art. But to populate this training data and learn, a system needs industry specific and discipline specific data, correlated to formulas and keywords. Such data doesn't exist in the prior art with respect to spreadsheets being converted into conversations because the process of automatically converting spreadsheets into conversations didn't exist in the prior art. The editing and rating functions in 313 and 316 of FIG. 3, are steady sources of this data from which statistical learning can take place with respect to question order, importance, rank, and logical correlation. The same process is applied to results presented to the user and, in case of complex spreadsheets, as identified in the system in 309 of FIG. 3, a similar process is applied to internal and external APIs triggered by keyword, industry, formula, and discipline combinations to replace the need for any user input with data generated by reliable sources.

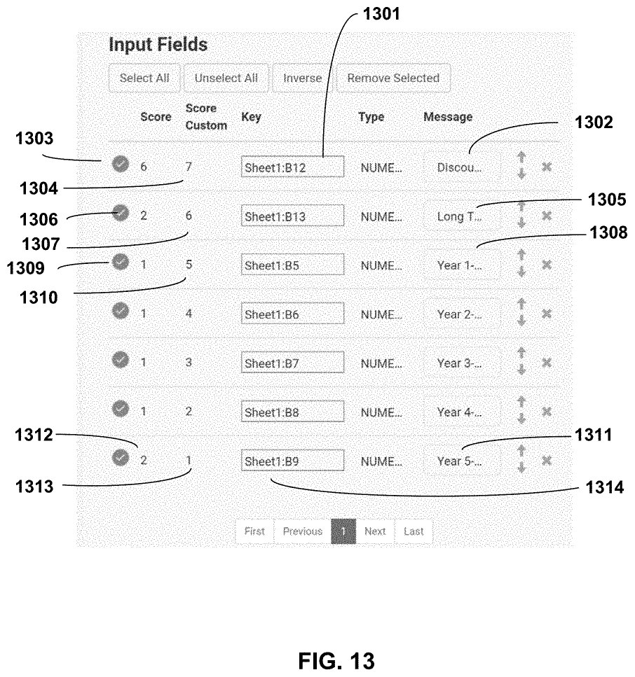

FIG. 13 is an illustration of an interface that incorporate an option to override, or edit, the automatic question and results presented to the bot user, as well as the order of such questions. You'll note that the system rank doesn't change as a result of the human bot creator changing the order or omitting an input (or output) from the interface. The system is designed so that only it can equally weight scores for a given input, as shown in 1306 and 1312 of FIG. 13, where the system score's the both inputs as “2”, with a lower number indicating less significance and therefore later order of presentation. For the same sample spreadsheet bot, however, the user scores 1305, “Long term sustainable growth rate cash flow to equity”, 6. Despite this, both the algorithmically generated order and the user edited order result in the same order of questions in the conversation with the bot user. This built in difference in ranking constrains enables easier identification and logging of training data to better inform question orders recommended by statistical learning. More important, the present invention makes it so that a bot creator that chooses to edit the bot logic in 316 of FIG. 3 in the case of an ordinary spreadsheet or 718 of FIG. 7 in the case of a complex spreadsheet, all the bot creator has to do is drag and drop the related question (input) or answer (output) to match the order they desire. The system logs this behavior and, if a similar pattern in a similar domain emerges enough times, will adjust the weighting and ranking routines applied appropriately.

So, for example, referring again to FIG. 13, the closed form ranking formula assumed that “Year 5”, 1311, cell 1314, was a more important question (input) because it was referenced twice as frequently as the four other inputs it determined were junior. However, this reference was specific to the industry and the domain. When making a discount cash flow model, or “DCF”, the last projected year is most often grown out by the sustainable growth rate in order to determine a long-term benefit stream that will be capitalized, or divided by the discount rate minus the long-term sustainable growth rate. Some variation of the terms, or character strings, just mentioned exists in the sample spreadsheet. Cataloging the occurrence and order of these terms to find patterns that help narrow down the specific significance of cells surrounded by terms similar to those near cell 1314 in FIG. 13, and correlating that with the move by multiple users in such circumstances to a lower rank, will result in the system ranking cell 1314 equivalents, the final projection year to an order that matches it's display order on the source spreadsheet being transformed.

You'll also notice that transforming the adjacent row label into question 1005 in FIG. 10 is appended by a nearby and intersecting column header detected by the system, to add more specificity to the question, adding the character string in 907 of FIG. 9 “Net Cash Flow To Equity.” This qualifier is important in each case, and by automatically including it the conversation can be completed by users with even cursory knowledge of the subject. If additional elaboration on terminology is required, cell comments, which are known in the art by spreadsheet users, are also brought in automatically to populate “help” buttons on the conversational bot or to respond to the word “help” when spoken or, “/help” and “help” when typed.

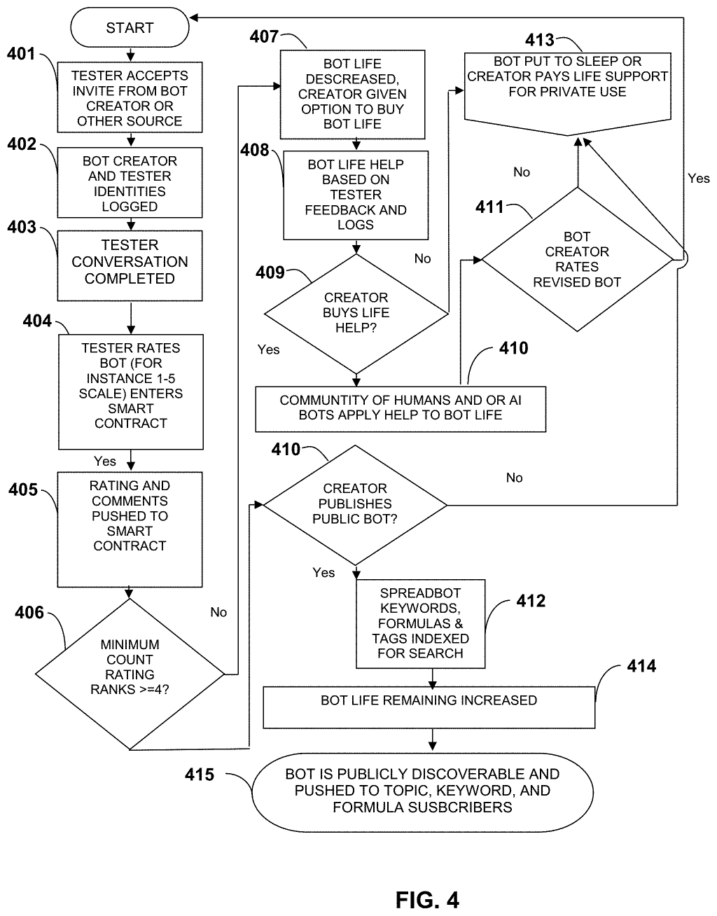

Referring again to FIG. 3, after the virtual instance of the draft (alpha) spreadbot is deployed, 311, and the bot creator tests, 312, and rates, four (4) out of 5 in the embodiment presented; bot life is increased 314 and the bot creator is able to Launch their beta spreadbot, 315 for testing by third parties. FIG. 4 shows the flow that starts with first time third party testers of the bot. The quality of the feedback and relevance of the testers recruited is critical to the success, and therefore expected life, of the bot. To help insure this requirement is met one embodiment of the present invention relies on smart contracts.

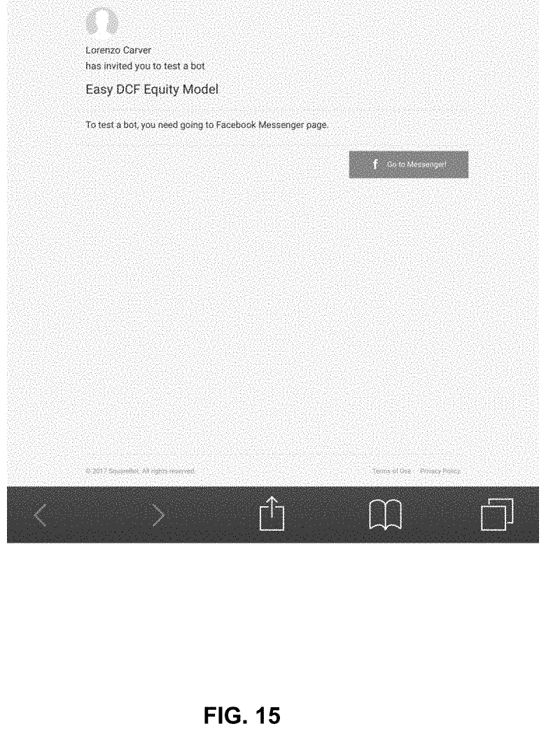

In 401 of FIG. 4, the bot tester accepts an invite from the bot creator or from another source. A sample of one such invitation, that includes deep linking and tracking connected to a smart contract, is displayed as FIG. 15. The invitation tracks the channel, time, and consensus rating, if any, of the tester and includes this information in an distributed, immutable ledger, so that the relative weight of the reviewer over time will have an impact on the bot life of this spreadbot as well as other spreadbots created by the bot creator, the bot tester, a machine or derived from the this spreadbot.

After the bot tester 401 of FIG. 4 completes the conversation 403 with the spreadbot under test, the tester has to rate the bot to complete the process. Again, their rating updates the bot life history and impacts the bot's projected life, or “charge” going forward, as illustrated in 1207 of FIG. 12. Once a minimum average quality, tentatively 4 out of 5, across a minimum quantity of testers, tentatively five (5), is achieved in 406 of FIG. 4, the bot creator has the option to publish the bot publicly, which will make it searchable against text, voice and uploaded document queries. If public, for instance, when a user uploads a wordpressing and pdf document, or even another spreadsheet, key words, patterns and formulas can be matched to public bots to suggest spreadbots that may help complete or understand the word, pdf or other type of file. Also, when the bot is publicly published, it's bot life is increased initially, since it benefits from community input and alternative prospective monetization opportunities.

If the minimum average quality, tentatively 4 out of 5, across a minimum quantity of testers, tentatively five (5), is not achieved in 406 of FIG. 4, the bot creator has the option to either publish the bot privately for their own use, for a fee or put the bot to sleep 413, or buy the resources needed to increase bot life from the community 408 and 410. If the bot creator purchase bot life from the community then the sequence of the bot creator rating the bot prior to testing is initiated again and follows the same flow from that point.

In the sample spreadsheet shown in FIG. 9, only one active worksheet was present. However, many spreadsheets in the art have more than one worksheet with calculations. There are two general cases for which spreadsheets with more than one active worksheet with calculations can be converted into well-organized conversations in accordance with the present invention. One case is where multiple sheets share calculations to achieve a single goal, as in 305 of FIG. 5, under which case the system will merge the logic of the sheets into a single conversational bot logic, but still enable editing that bot logic across multiple sheets. The other case is where multiple sheets with calculations occupy the same workbook but do not share calculation references, as is the case in 306 of FIG. 3. In this latter case, the system will create a separate bot logic for each such sheet and present individual images for each sheet arrayed across a card selection carrousel, or similar UI element. The description of each nested bot resulting will be automatically populated based on the worksheet tab label, so no additional user input will be required to generate all nested bots automatically.

If a spreadsheet is determined by the system to be “complex” in 309 of FIG. 3, the complex bot routine outlined in FIG. 7 is initiated. The goal is to minimize the amount of complexity that must be exposed to the spreadbot end user, as it's assumed that the greater the number of inputs the less likely an average spreadbot user is to complete their conversation. Steps 702 through 710 of FIG. 7 are primarily aimed at grouping collections of cells contents with similar attributes into areas that can be deciphered and matched with known patterns, formulas and keywords from related domains in 711. As matches are made and areas reduced, nested bots similar to those created in cases where independent worksheets with calculations were nested in 306 of FIG. 3. By breaking the complex spreadsheet into its key elements automatically, a bot creator can see if any APIs automatically selected by the system 711 to eliminate the need for user input are consistent with their subject matter expertise that was embedded in the source spreadsheet.

What is claimed is:

1. A method and system implemented on a handheld computer, mobile phone, desktop, implanted, wearable, decentralized, distributed or other computer system whereby users can have conversations with spreadsheets that have been transformed into conversational robots, with the system allowing spreadsheet owners to convert their spreadsheets into conversational robots for public or private use, bot users being able to discovering new conversational spreadsheet robots (spreadbots), by searching using keywords spoken or typed or by simply uploading a document and all activity during the SpreadBot lifecycle being recorded in a smart contract's immutable ledger to inform bot life and future bots.

2. The method of claim 1 wherein APIs are automatically matched to spreadsheet input contents to reduce the number of questions and answers needed in a conversation to get the bot user to an accurate answer and useful outcome
